(19) United States
(12) Patent Application Publication
(10) Pub. No.: US 2015/0278729 A1
(43) Pub. Date: Oct. 1, 2015

(54) COGNITIVE SCORING OF ASSET RISK BASED ON PREDICTIVE PROPAGATION OF SECURITY-RELATED EVENTS

(71) Applicant: International Business Machines Corporation, Armonk, NY (US)

(72) Inventors: XIN HU, Yorktown Heights, NY (US); Reiner Sailer, Yorktown Heights, NY (US); Douglas Lee Schales, Yorktown Heights, NY (US); Marc Philippe Stoecklin, Bern (SZ); Ting Wang, Yorktown Heights, NY (US)

(73) Assignee: International Business Machines Corporation, Armonk, NY (US)

(21) Appl. No.: 14/229,155

(22) Filed: Mar. 28, 2014

(51) Int. Cl. G06Q 10/06

(52) U.S. Cl. CPC G06Q 10/0635

(57) ABSTRACT

A method (and system) of scoring asset risk includes determining, using a processor, a risk value for each entity of a plurality of entities within a network and ranking each risk value.

### BACKGROUND OF THE INVENTION

1. Field of the Invention

The present invention generally relates to a method and system for scoring asset risk.

2. Description of the Related Art

Internet security is often a top priority for entities of all types and sizes. Cyber security threats have become increasingly sophisticated and subtle. Such threats have evolved from isolated, proof-of-concept attacks to multi-stage, organized efforts whose footprints spread across multiple channels. Understanding risks to high value assets has become unprecedentedly important for enterprises to prioritize security resources, take early precautions and protect the integrity of their proprietary information.

Current enterprises have deployed certain security protections, such as anti-virus software, intrusion detection systems (IDS), intrusion prevention systems (IPS), blacklists, firewalls, etc, in their networks and inside devices that connect to those networks. With all these up-to-date technologies capturing every instance of security violation, a problem facing security departments is the arduous task of analyzing the enormous amount of information relating to security events and detecting the real (i.e. actual) risk. In other words, legitimate risks and threats may be buried under a deluge of false alarms.

Each day, a typical IPS system generates tens of thousands of alerts. A majority of those alerts are false positives or suspicious security violations (e.g., visiting a blacklisted webpage, brute force password guess, or Structured Query Language (SQL) injection attempts) that are not necessarily malicious. Even those that are malicious do not necessarily pose any practical security threats to the enterprise.

Unfortunately, the number of events and alerts has already exceeded the capability of manual analysis. The bounds of practicality dictate that each and every alert cannot be analyzed. Hence, these alerts often lie in a database only for forensic purposes and are investigated only when events of more significant importance happen (e.g., security breaches, data leakage). Quite often, it is already too late to prevent the damage.

Conventional systems are often rule based. Thus, they may not be able to detect novel attacks or variations of existing attacks whose signatures are not yet devised. Further, there is usually a long time window between emergence of new attacks and creation of the IDS/IPS signatures by security experts, potentially leaving a dangerous time window for adversaries to cause damages.

Conventional systems also typically focus on a single event, failing to reveal correlation among multiple events which is often critical in detecting APT (Advanced Persistent Threats).

Further, conventional solutions cannot measure how serious a security event is. Hence, important security events may be lost among thousands of irrelevant small alerts. Traditional IDS/IPS provides no evaluation on the potential risks of security alerts to enterprise assets.

Finally, conventional approaches are used mainly for Post-Mortem Forensic Analysis while risk analysis can help detect potential vulnerabilities inside enterprise and allow precaution to be taken in an early stage.

### SUMMARY OF THE INVENTION

In view of the foregoing and other exemplary problems, drawbacks, and disadvantages of the conventional methods and structures, an exemplary feature of the present invention is to provide methods and systems for scoring asset risk.

In a first aspect of the present invention, a method of scoring asset risk includes determining, using a process, a risk value for each entity of a plurality of entities within a network and ranking each risk value.

In another exemplary aspect of the present invention, a system for scoring asset risk includes a risk determining unit for determining a risk value of a plurality of entities within an enterprise system and a risk ranking unit for ranking updated risk values of the plurality of entities within an enterprise system.

Yet another exemplary aspect of the present invention includes a non-transitory computer-readable storage medium tangibility embodying a program of machine-readable instructions executable by a digital processing apparatus to perform an instruction control method including determining a risk value for each entity of a plurality of entities within a network and ranking each risk value.

In still another exemplary aspect of the present invention, a method for cognitive scoring of asset risk based on predictive propagation of reputation-related events includes modeling an interdependence of risks of a plurality of entities within a network and applying a Belief Propagation (BP) algorithm which obtains risk information related to each entity of the plurality of entities, wherein the BP algorithm obtains the risk information based on a reputation of the each entity and a reputation of a neighboring entity of the each entity.

In view of the above and other exemplary embodiments, exemplary benefits of the present invention may include, among others, an ability to capture the effects of inter-connectivity between entities based on their overall risks, design of a scalable and robust framework that allows simultaneous determination of risks of all entities, efficient model propagation of security risks over a connectivity graph, the derivation of meaningful rankings of risks for entities and incorporation of domain knowledge to help improve risk assessments.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a workflow of an exemplary system according to an exemplary embodiment;

FIG. 2 illustrates a belief propagation workflow according to an exemplary embodiment;

FIG. 3 illustrates an exemplary system according to an exemplary embodiment; and

FIG. 4 illustrates an enterprise environment used in accordance with an exemplary embodiment.

### DETAILED DESCRIPTION OF EXEMPLARY EMBODIMENTS OF THE INVENTION

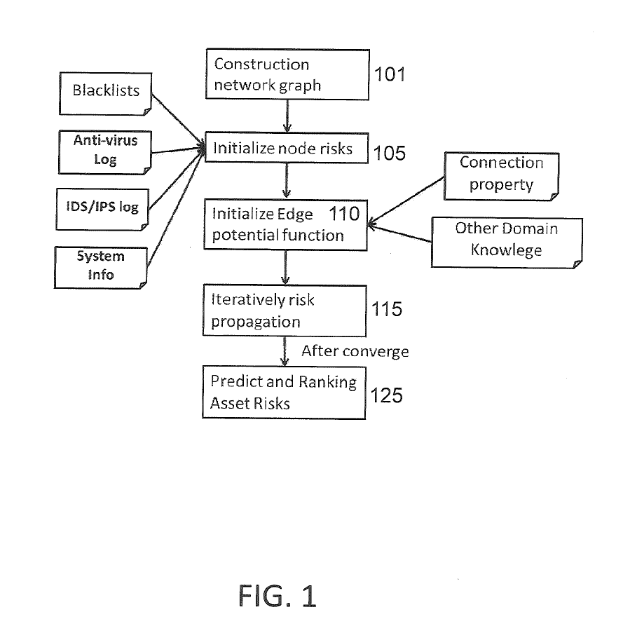

Referring now to the drawings, and more particularly to FIGS. 1-4, there are shown exemplary embodiments of the method and structures according to the present invention.

Risks related to assets (e.g., external servers, internal endpoints, users) are not isolated. They are correlated and depend on the link structure (interaction) between assets. For instance, an internal endpoint device is likely to be of high risk if: 1) the websites to which it frequently connects are considered suspicious/malicious, 2) the users of the internal endpoint have a bad reputation, 3) the credentials used to log into the devices have high risks of being compromised, and/or 4) it accesses high value assets.

At the same time, a user can have a low reputation if, for example, he/she is the owner of low-reputation devices and/or he/she has used high-risk credentials to log in to low-reputation devices. Similarly, a credential can be at risk if it has been used by a less reputable user or on suspicious devices. Finally, a high value asset is more likely to be under high risk if it receives connection/accesses from multiple low-reputation devices.

Thus, if suspicious entities are flagged based only on individual security events, some risky entities may be overlooked or miss-prioritized. Indeed, intuitively, one can see that these reputation and risks are correlated and interdependent. Similarly, a credential's risk of being exposed should increase if it has been used in a less reputable device.

On the other hand, a device's reputation should decrease if a leaked credential is used to access the machine and thus risking being used by an unauthorized user. Further, the reputation of a device could in turn propagate through the connection to high value assets and increases the overall risks posted to these assets.

To efficiently capture this inter-dependence, it can be possible to exploit such inter-dependence in a multi-layer mutual reinforcement framework.

In certain exemplary embodiments, the present invention can incorporate a risk analysis framework which can utilize mutual reinforcement and risk propagation principles. The framework may include models and algorithms to systematically quantify and rank the risk to high value assets of an enterprise based on multi-channel data sources such as blacklists, external servers, users and device properties. The risk of each entity can be evaluated using the entity's temporal behaviors as well as the entity's interaction with remote servers, peers and high value assets, among other things.

The present invention can utilize a scalable risk propagation algorithm on a communication graph to propagate and aggregate the risks of networked entities. By ranking the high risk devices, the present invention allows Information Technology (IT) departments to make informed decisions on the allocation of resources for further investigation, such that more important and severe cases can be investigated first and damages prevented at the earlier stage of the attacks.

Using risk propagation and link analytics that correlate multiple security events and exploit link structure between entities, one can obtain a global picture and re-rank the risky entities not only based on security events in a single entity, but also based on its interaction with other entities. As a result, methods and systems for aggregating security events, providing a global picture of asset risks and ranking their risks can be very useful for, among other things, analysts to prioritize resources, take early precautions and protect integrity and confidentiality of their high value assets.

In a typical enterprise network, we may consider five distinct exemplary types of entities: users U, devices D, credentials C, High value assets A, and external servers S to which devices D connect. These entities are often related in a pairwise many-to-many relationship. A pairwise many-to-many relationship describes where one or more entities of a certain type can be associated with one or more entities in another type. For example, one user can own multiple devices (laptops, servers, phones) and one device (server) may be used by multiple users.

Further, a device can access multiple external websites and a single website can be visited by multiple devices. Similarly, a user can own several devices, e.g., laptops and workstations, while one device (e.g. server clusters) can be used by multiple users.

Below, risk and reputation for these entities are defined more precisely.

For example, an External Server Reputation includes a score between 0 and 1 indicating a server's likelihood of infecting or compromising a client machine. The value is based on a type of the server (e.g., malware, phishing, botnet, etc). Further, a Device Reputation includes a score between 0 and 1 indicating the likelihood a device may be compromised.

Similarly, a User Reputation includes a score between 0 and 1 indicating the likelihood that a user may be suspicious.

Further still, a Credential Reputation includes a score between 0 and 1 indicating the likelihood that a credential may have been leaked to the adversaries and thus making any server associated with the credentials vulnerable.

Additionally, a Risk of High Value Assets includes a score between 0 and 1 indicating the risks associated with high value assets such as unauthorized accesses, data, leakage, etc.

The present invention models the inter-dependence and correlation of entity risks using the mutual reinforcement principle.

FIG. 1 illustrates a workflow of an exemplary system according to an exemplary embodiment of the present invention.

In the system, element 105 of the system of FIG. 1 achieves construction of a network graph. That is, first we model a network as a graph connecting different entities: E={U,D,C,A,S}.

As noted above, U denotes users, D denotes devices, C denotes credentials, A denotes high-value assets and S denotes external servers to which devices D connect.

Mathematically speaking, a graph can be defined as a set of vertices (V) and a set of Edges (E). Assuming there are N vertices in the graph, the graph can be represented by an N-by-N adjacency matrix. Specifically, in the adjacency matrix, the non-diagonal entry aij is the number of edges from vertex i to vertex j, and the diagonal entry aii, is the number of edges (loops) from vertex i to itself. In exemplary embodiments of the present invention, since we have multiple types of entities, the vertex set consist of S, D, U, C, A, and we define an adjacency matrix for each pair of entities that share certain relationship.

Further, the graph can be represented as:

G={S,D,U,C,A,M_{DS},M_{DU},M_{DA},M_{UC},M_{DC}}, where M_{DS} is a |D|-by-|S| matrix representing edges between entity internal endpoint devices and external services, M_{DU} is a |D|-by-|U| matrix representing edges between entity internal endpoint devices and users, M_{DA} is a |D|-by-|A| matrix representing edges between entity users and credentials, M_{UC} is a |U|-by-|C| matrix representing edges between entity internal endpoint devices and high-value assets, M_{DC} and is a |D|-by-|C| matrix representing edges between entity internal endpoint devices and credentials.

The mutual reinforcement principle can be expressed as follows:

p_{d}∂w_{ds}M_{ds}pₛ+w_{du}M_{du}pᵤ+w_{dc}M_{dc}p_{c}

pᵤ∂w_{du}M_{ud}^{T}p_{d}+w_{uc}M_{uc}p_{c}

p_{c}∂w_{cd}M_{dc}^{T}p_{d}+w_{uc}M_{uc}^{T}pᵤ

rₐ∂1−(w_{da}M_{da}^{T}p_{d}+wᵤₐMᵤₐ^{T}pᵤ+w_{ca}M_{ca}^{T}p_{c})

In the mutual reinforcement principle detailed above, relationships governing server reputation pₛ, the device reputation p_{d}, user reputation pᵤ, credential reputation p_{c} and resulting risks to high value assets rₐ are shown.

Then, element 110 initializes node risks. Indeed, in certain exemplary embodiments, the present invention computes a reputation for each entity with respect to the risk that entity poses to the high value asset. We may treat each entity as associated with a random variable Xε{x_{g}, x_{b}}, where X_{g} is a “good” label and x_{b} is a “bad” (or malicious) label. Then, an entity's reputation can be expressed as P(x_{g}), i.e., a probability of being good. This approach is consistent with the previous discussion of factors relating to reputation. In other words, an entity with a high reputation is more likely to be good. Similarly, the risks of a device to the high value asset can be expressed as P(x_{b}), i.e., a probability of being risky to the assets. Note that these two probabilities P(x_{g}) and P(x_{b}) sum to one.

To efficiently compute the probability for all entities in a large graph, the present invention utilizes a Belief Propagation (BP) algorithm, which has been successful in solving many inference problems over graphs. A Belief propagation algorithm is a messaging passing algorithm for performing inference on graphical models. Some exemplary advantages of this algorithm include that it is very general and can be applied to any graphical model. Further, it scales to large graphs and can be parallelized easily. Belief propagation is commonly used in artificial intelligence and information theory and has demonstrated empirical success in numerous applications including low-density parity-check codes, turbo codes, free energy approximation, computer vision and satisfiability.

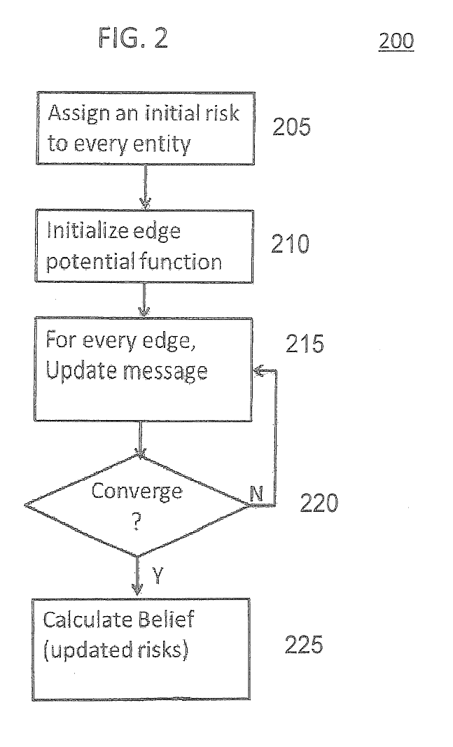

FIG. 2 illustrates an exemplary workflow of a BP algorithm according to an exemplary embodiment of the present invention.

At a high level, the algorithm infers the reputation of a node (an entity that belongs to E={U,D,C,A,S}) in the graph from some prior knowledge about the node plus information about the nodes neighbors. In other words, risks of an entity are inferred from 1) the entity's own properties and 2) surrounding entities.

As shown in Step 205, an initial risk is assigned to each entity. The present invention incorporates domain knowledge to assign initial risk (node potential) to each entity. In particular, we assign different initial risks to external servers based on their malicious types. For high-risk types such as botnet C&C, exploit websites, a high risky potential is assigned to them such as (φ(xᵣ), φ(xₙᵣ))=(0.9, 0.1). For low-risk types such as spam, malware, we assign a lower value such as (φ(xᵣ), φ(xₙᵣ))=(0.6, 0.4). For other entities, such as internal endpoints, users, credentials, information such as operating systems, patch level, compliance level, can be used to adjust the node potential. For entities where no prior knowledge is available, we assign a default value to them: (φ(xᵣ), φ(xₙᵣ))=(0.5, 0.5).

Here domain knowledge can refer to any information/knowledge about a particular node. It can be information from human experts (e.g., an IT specialist determines the initial risk of a device based on its operating systems, software installed). It can also be obtained from information collected from activity or traffic of particular nodes, such as access of malicious websites, infection of virus. It can also be extracted from IDS/IPS or antivirus systems (e.g., alerts associated with the nodes or virus report, etc.) Domain knowledge is very general, comprising any information that can be used to deduce the potential risks of a node.

In various exemplary embodiments, the initial risks are determined empirically and possibly assigned by experts before executing the main iterative belief propagation algorithm. In the example above, the value 0.6 is determined by the characteristics of the nodes. In this case, because accessing a spam website could simply be due to mis-clicking a link in spam email, such does not necessarily indicate that the device has been compromised. Thus, the likelihood of the device being risky is low, so we assign a relatively neutral value (i.e., 0.6, 0.4) to the node's initial risk.

To the contrary, if a device visits a bot C&C (command and control) server which is a strong indication that the device has been infected by botnet malware, we assign a high risky score (0.9, 0.1).

In summary, the values of initial risks are initial parameters for the propagation algorithm that are determined based on domain knowledge and other information.

As shown in Step 210, an edge potential function is initialized. Referring back to FIG. 1, element 110 can achieve such initialization of an edge potential function. Indeed, in various exemplary embodiments, the present invention also adapts connectivity for adjusting edge potential function. In general, edge potential function Ψ(xᵢ, xᵢ) can take the form of a matrix with a small noise parameter ε. That is, if xᵢ is risky, xⱼ has a slightly higher probability of being risky as well and vice visa. In other words, thinking of the age-old adage that “if you lie down with dogs, you wake up with fleas”, it stands to reason that if a first entity with which a second entity will interact is risky, this may also affect the risk level of the second entity.

With respect to edge potential function, we convert the connectivity between the nodes into their edge potential based on the mutual reinforcement principle. First we consider a domain diversity weight w^{d}, which attempts to differentiate devices that visit a diverse range of malicious domains from those that frequently access the same sites multiple times.

The intuition is that an advanced threat often involves activities of multiple malicious types. Therefore, the likelihood or risk of a device being compromised should increase if it visited a diverse set of malicious domains. On the other hand, repeated visits of the same malicious websites should be discounted in risk computation. For each malicious type, the domain diversity weight is defined as:

wᵢ^{d}(nᵢ):Nᵢ→R.

Specifically, what the above relationship states is that wᵢ^{d}(nᵢ) is a monotonically increasing function of nᵢ. Thus, wᵢ^{d}(nᵢ) becomes higher as the devices visit multiple different domains as compared to those that connect to a single domain.

Additionally, to avoid being over-shadowed by a few outliers, a sigmoid function is used to ensure that the weights are bounded and the increase slows down when nᵢ becomes very large. Formally, we define:

wᵢ^{d}(nᵢ)=2/(1+e^{-ni/3})

One exemplary goal is to simultaneously determine the reputation of all the entities and their risks to high value assets.

Next, iterative message passing is performed in Step 215, wherein it is illustrated how iterative message passes between all pairs of nodes nᵢ and nⱼ. Element 115 of the system of FIG. 1 is capable of performing such message passing. For reference, let denote a “message” sent from i to j. Intuitively, the message represents i's influence on j's reputation, which in some sense can be viewed as that i passes some “risk” to node j. In other words, the message (mᵢⱼ) is passed from entity i to entity j based on the impact i has on j. Additionally, prior knowledge about the node i (i.e., the characteristics of node i such as device type, patch level, importance, etc,) is expressed through a node potential function Φ(i) which plays a role in determining the magnitude of the influence passed from i to j.

In detail, each edge ei;j is associated with message mi;j (and mj;i when the message passing is bi-directional). Each outgoing message from a node i to a node j is generated based on incoming messages from the node's other neighbors as well as the node potential Φ(i). Iteratively, messages are updated using the sum-product algorithm. Each outgoing message from a node to a neighbor is updated according to incoming messages from the node's other neighbor.

Mathematically, the message update equation for Step 215 in BP is:

$${m}_{i , j} ( {x}_{j} ) ← {\sum }_{{x}_{i}} {φ}_{i} ( {x}_{i} ) {ψ}_{ij} ( {x}_{i} , {x}_{j} ) {\prod }_{k ∈ N ( i ) \backslash j} {m}_{k , i} ( {x}_{i} )$$

where N(i) is the set of nodes neighboring node I and ψ(i,j) represents the “edge potential,” which is a function that transforms a node's incoming messages into the node's outgoing messages based on characteristics of node i and node j, and their inter-connection property.

The algorithm stops when the whole network converges with some threshold T (i.e. the change of any m_{i,j} is smaller than T), or a maximum number of iterations are finished. In other words, a convergence occurs when the change in message is less than a threshold. Whether or not a convergence has occurred is determined in Step 220. If a convergence has not occurred (i.e. answer “N”), then Step 215 will continue. If a convergence has occurred (i.e. answer “Y”), then the BP algorithm will move forward to the next step.

Indeed, if a convergence has occurred (Y), then Step 225 will begin, and a belief will be calculated (i.e., updated risks). Again referring back to FIG. 1, element 125 can calculate such a belief. The result of the calculation can be used to predict and rank asset risks.

At the end of convergence (i.e., at the end of the propagation procedure), the risk score is determined in Step 220 as follows:

$${b}_{i} ( {x}_{i} ) = k {φ}_{i} ( {x}_{i} ) {\prod }_{j ∈ N ( i )} {m}_{j , i} ( {x}_{i} )$$

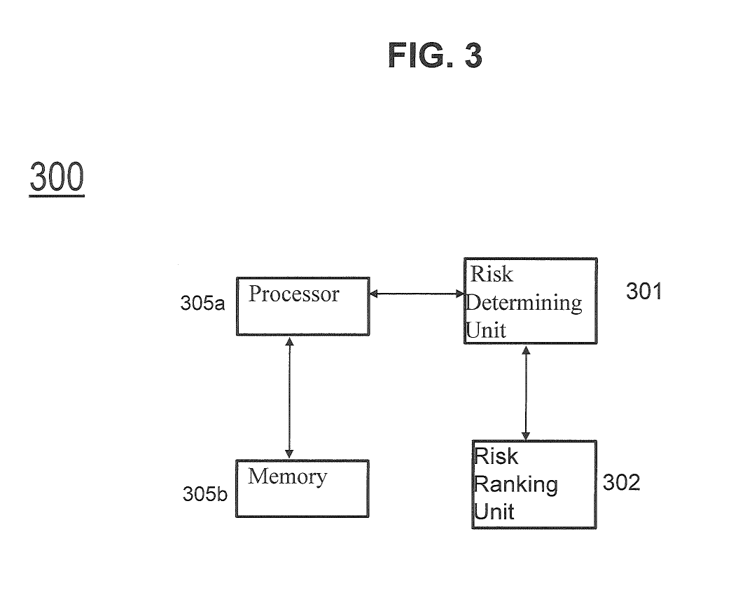

FIG. 3 illustrates an exemplary system of the present invention. The system includes a risk determining unit 301, a risk ranking unit 302, a processor 305a and a memory 305b. The risk determining unit 301 can determine a risk value of one or more entities within an enterprise system. The risk ranking unit 302 can update risk values of said plurality of entities within an enterprise system. It is noted that both the risk determining unit 301 and the risk ranking unit 302 may include one or more of the various components discussed above, and/or utilize one or more of the various steps discussed above, with respect to FIGS. 1 and 2. The memory 305b can tangibly embody instructions for the processor 305b to execute.

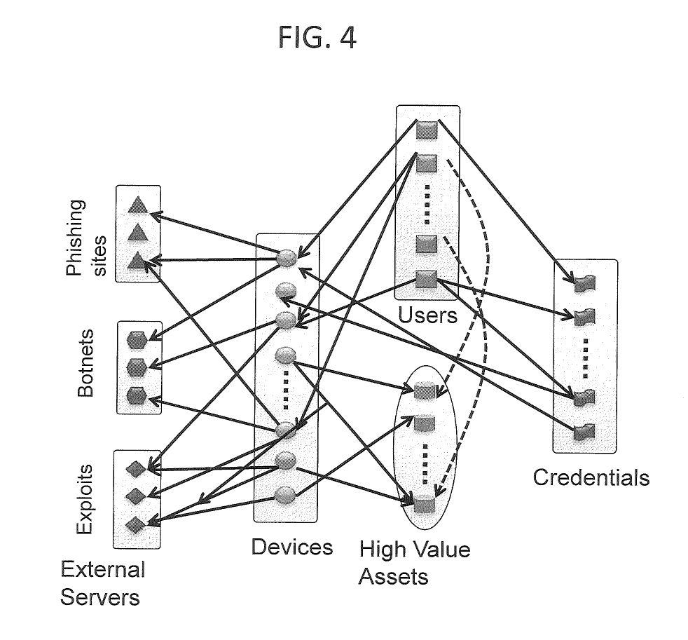

FIG. 4 illustrates an enterprise environment used in accordance with an exemplary embodiment of the present invention. The figure shows abstraction of an enterprise environment into multiple correlated entities. The figure represents an exemplary interaction between different entities and their relationship(s).

To efficiently execute the above mentioned algorithms, we want to determine the correct function for node potential and edge potential based on the characteristics of nodes (e.g. devices, credentials) and edges (connectivities). This is to capture the intuition that low reputation entities are slightly more likely to be associated with other low reputation entities. This is similar for high reputation entities. The transition matrix is as follows:

$$\begin{matrix}Ψ ( {x}_{i} , {x}_{j} ) & {x}_{j} = risky & {x}_{j} = non \text{-} risky \\ {x}_{i} = risky & 0.5 + ω * ɛ & 0.5 - ω * ɛ \\ {x}_{i} = non \text{-} risky & 0.5 - ω * ɛ & 0.5 + ω * ɛ\end{matrix}$$

The parameter ω is the weight based on the connectivity between xᵢ and xⱼ to capture the fact that, if two entities have frequent connection (e.g., an internal endpoints repeated visit malicious websites, e.g. botnet), they potentially have higher correlation than those that are connected by each other. To bound the ω so that it is not skewed by outliers, it takes the form of ω=1/(1+exp(−1*n)) where n is the number of connections. The parameter ε is a noise parameter discussed above.

We now describe characteristics relating to domain knowledge of each entity and how to incorporate such into the reputation propagation framework as a whole.

We start with characteristics of External Servers (S). Several external blacklists may be used to analyze the HTTP traffic and detect types of suspicious web servers to which internal devices have made connections. This allows measurement of the maliciousness of the external servers and mapping of their malicious type (e.g., spam, phishing, botnet) to a node potential Φ(eₛ) where eₛ εS. More specifically, each external server is classified into one of the following types.

A first exemplary type includes “Spam Websites”, which include servers that have been marked by external blacklists (e.g. Spamhuas) as spam sites. Spam websites are common hosts for adware, spyware, malware and other unwanted programs that may infect the client machine.

A second exemplary type includes “Malware Websites”, which include servers that host malicious software. These malware programs often propagate to user machines through download or vulnerabilities of browsers.

A third exemplary type includes “Phishing Websites” which include servers that purport to be popular sites, such as bank sites, social networks, online payment or IT administration sites, in order to lure unsuspecting users to disclose their sensitive information e.g., user names, passwords, and credit card details. Recently, attackers have started to employ more targeted “spear phishing” attacks which use specific information about the target to increase the probability of success. Thus, phishing attacks have become a major threat to enterprises. Due to the potential high success rate of such attacks, a high value is assigned as its node potential.

A fourth exemplary type includes fast flux and name generation bot net domains. Botnet comprises a large number of compromised computers under command and control of a single “botmaster”. Making use of this large pool of IP addresses, botnet uses fast flux strategy as their web hosting infrastructure. A fast flux botnet domain frequently changes mappings between domain name and IP address to evade IP based detection and provide better availability of the nefarious contents.

Similarly, name generation is a technique of frequently changing domain names to defeat hostname based detection. Hence, if any internal device has visited fast flux or name generation domains, there is a high possibility that the machine may have been infected by the bot program, thereby lowering its reputation.

A fifth exemplary type includes Botnet Command & Control (C&C) servers. Bot programs regularly contact their masters' command and control servers for instructions or to extrude confidential information. If an internal device makes an attempt to connect to a known botnet C&C server, the chances that the device have been compromised increases and thus so does its risk.

A sixth exemplary type includes websites hosting an exploit toolkit. Web exploit toolkits are made by highly skilled hackers and sold to less sophisticated attackers, allowing them to set up attacks that are otherwise too complicated for them. The toolkits often comprise a number of exploits and can be easily configured to exploit vulnerabilities of a browser for downloading malware or stealing information when an unsuspecting user visits the website. Popular exploit toolkits such as “Black Hole” have been observed being used to spread various adware, malware and botnets. Devices that access the exploit toolkit websites thus have potential risks of being compromised.

While the above list includes many exemplary server types, it is merely exemplary and is not intended to preclude other exemplary server types. The present invention is not limited to the above exemplary list and various other server types within the spirit and scope of the present invention have been contemplated herein.

After determining the server type, a node potential function Φ(sᵢ) is used to map each type into the server initial reputation. In particular, the following exponential mapping function may be used:

initial server reputation, SR=e^{-1*wt}

where wₜ is the weight assigned to each type (i.e. spam, botnet, malware, exploit, etc). The magnitude of the weight can be determined based on the maliciousness of the website and/or the likelihood of compromising a client machine.

For instance, w may be set to a value of 1 for a spam server and 20 for a botnet C&C, because visiting a spam domains is much less likely to cause a client machine to be infected than visiting a botnet C&C, which is almost a certain indication of infection of some bot program.

We now move on to Characteristics of Local Devices (D). A device's initial reputation can be determined, for example, by its available properties. Such available properties may include: device type (i.e. mobile devices, laptop, desktop, workstation, etc), operating system (OS) type (i.e. Windows, linux, MAC, android, iOS, etc), configuration (i.e. patch level, firewall configuration, freshness of AV signatures, etc), and security events (i.e. alerts from IDS, IPS systems for the devices, etc).

An exponential mapping function can be used to convert these characteristics into the initial reputation:

initial device reputation: DR=e_{-1*wd*w(device-property)}

where w(device-property) is a weight derived from the above mentioned characteristics.

For example, a high weight should be assigned to a device that is running an out-of-date operating system with unpatched security vulnerabilities. W_{d} is a diversity weight designed to account for diversities in the type of malicious websites accessed by the devices. A higher diversity weight is assigned to devices that have accessed multiple types of malicious websites. The rationale behind assigning a higher weight to such devices is that advanced attacks often involves multiple types of threats such as phishing, botnets, etc.

For instance, visiting exploit websites may lead to infection by a bot program, which connects back to the C&C servers. As a result, the risk propagated through the device is increased using the diversity weight as:

w_{d}=1+(m−1)/N

where m is the number of different types of malicious servers connected by the device, N is the total number of malicious server types, and 1≦m≦N, 1≦m≦6.

We now move to Characteristics of Users (U). As the owner of the devices and credentials, a user's roles may impact how the reputation is propagated. The following exemplary characteristics of a user may be considered.

First, a “user role” is explained. Depending on a user's job position, he/she may have various privileges. A user with higher privilege such as a vice president or a manager may potentially increase the risk that passes through his/her node.

We also consider suspicious user behavior. For example, user analytics may be applied to detect whether any suspicious activities, such as unauthorized accesses, etc., have been associated with the user. Any suspicious behavior will increase the risk propagated through this user.

We now discuss characteristics of High Value Assets (A). Each high value asset is assigned a value according to the asset's type and importance to the business. Similarly, node potential is an increasing function with regards to the asset value. A potential risk against higher-value assets should be amplified to reject its potential damages.

In an exemplary embodiment, the importance of high value assets/credentials and user privilege is considered as well. Importance of high value assets can be determined by the value of the assets such as sensitive personal information, private customer data, etc. Similarly the importance of the credentials depends on the importance of its owner (e.g. the password used by the CEO is more important than that of normal users). These importance values can be used as weight factors to adjust the initial risk scores of different entities, much like how the initial risk of a device is derived.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the to flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of scoring asset risk, said method comprising:
determining, using a processor, a risk value for each entity of a plurality of entities within a network; and
ranking each risk value.

2. The method of scoring asset risk according to claim 1, wherein said determining includes assigning an initial risk value based on domain knowledge.

3. The method of scoring asset risk according to claim 1,
wherein said risk value is determined based on an initial risk value, and
wherein said determining further includes analyzing a reputation of said each entity.

4. The method of scoring asset risk according to claim 3, wherein said analyzing is based on at least one of an exposure level of said each entity and a behavior of said each entity.

5. The method of scoring asset risk according to claim 3, wherein said analyzing includes correlating said reputation of said each entity between entities.

6. The method of scoring asset risk according to claim 4, wherein said exposure level is determined based on one or more of an entity interaction, information regarding a neighboring entity, a use of a high-value asset and a message passing between entities.

7. The method of scoring asset risk according to claim 4, wherein said behavior of said each entity is determined based on prior known information.

8. The method of scoring asset risk according to claim 5, wherein said correlating comprises applying a Belief Propagation (BP) algorithm.

9. The method of scoring asset risk according to claim 8, wherein said applying said BP algorithm includes performing an iterative message passing.

10. The method of scoring asset risk according to claim 8, wherein said BP algorithm is applied until a change in a message is less than a threshold value.

11. The method of scoring asset risk according to claim 8, wherein said correlating further comprises modeling one or more entity relationships in a bipartite graph.

12. The method of scoring asset risk according to claim 11, wherein said applying said BP algorithm includes utilizing information in said bipartite graph.

13. The method of scoring asset risk according to claim 1, wherein each entity of said plurality of entities comprises one of a user, a device, a credential, a high-value asset, and an external server.

14. A system for scoring asset risk, said system comprising:
a processor;
a memory tangibly embodying instructions for said processor to execute;
a risk determining unit for determining a risk value of a plurality of entities within an enterprise system; and
a risk ranking unit for ranking risk values of said plurality of entities within an enterprise system.

15. The system for scoring asset risk according to claim 14, wherein said risk determining unit:
assigns an initial risk value to each entity of said plurality of entities;
initializes an edge potential function for at least one edge between entities; and
performs an iterative message passing between entities of said plurality of entities.

16. The system for scoring asset risk according to claim 14, wherein said risk value includes one or more of an external server reputation, a device reputation, a credential reputation and a risk of a high value asset.

17. The system for scoring asset risk according to claim 15, wherein said iterative message passing is performed until a change value of a message is less than a predetermined threshold value.

18. The system for scoring asset risk according to claim 17, wherein said risk ranking unit ranks said updated risk values after said change value of said message is less than said predetermined threshold value.

19. A computer program product for scoring asset risk, the computer program product comprising a computer readable storage medium having program instructions embodied therewith, the program instructions readable by a computer to cause the computer to perform the method according to claim 1.

20. A method for cognitive scoring of asset risk based on predictive propagation of reputation-related events, said method comprising:
modeling an interdependence of risks of a plurality of entities within a network; and
applying a Belief Propagation (BP) algorithm which obtains risk information related to each entity of said plurality of entities,
wherein said BP algorithm obtains said risk information based on a reputation of said each entity and a reputation of an entity connected to said each entity.
